(19) United States
(12) Patent Application Publication
(10) Pub. No.: US 2026/0113824 A1
(43) Pub. Date: Apr. 23, 2026

(54) LIGHT-EMITTING DEVICE PERFORMING LIGHT EMISSION SUITABLE FOR SOUND SOURCE OUTPUT FROM OUTSIDE AND LIGHT EMISSION CONTROL DEVICE CONTROLLING LIGHT EMISSION

(71) Applicant: FANLIGHT CO., LTD., Seoul (KR)

(72) Inventors: Kyung Il CHOI, Seoul (KR); Jung Min CHOI, Seoul (KR)

(73) Assignee: FANLIGHT CO., LTD., Seoul (KR)

(21) Appl. No.: 19/424,490

(22) Filed: Dec. 18, 2025

Related U.S. Application Data
(63) Continuation of application No. PCT/KR2024/007662, filed on Jun. 4, 2024.

(30) Foreign Application Priority Data
Jun. 22, 2023 (KR) 10-2023-0080378

(51) Int. Cl. H05B 47/12; H05B 47/19

(52) U.S. Cl. CPC H05B 47/12; H05B 47/19

(57) ABSTRACT

A light emission control device includes an antenna, a communication unit, a sensing unit, and a processor connected to the antenna, the communication unit, and the sensing unit. The processor receives a sound source output from the outside through the sensing unit. When the light emission control device is equipped with a database in which at least one sound source and light emission control information respectively mapped to the at least one sound source are stored, the processor searches the database for light emission control information mapped to a sound source identical to the received sound source. When the light emission control device is not equipped with the database, the processor generates light emission control information for instructing light emission of a specific color and pattern based on the received sound source, and transmits a light emission control signal corresponding to the searched or generated light emission control information.

### CROSS-REFERENCE TO RELATED APPLICATIONS

This application is a continuation of International Application No. PCT/KR2024/007662 filed on Jun. 4, 2024, which claims priority to Korean Patent Application No. 10-2023-0080378 filed on Jun. 22, 2023, the entire contents of which are herein incorporated by reference.

### TECHNICAL FIELD

The present disclosure relates to a light-emitting device and a light emission control device. More specifically, the present disclosure relates to a light-emitting device that performs light emission suitable for a sound source output from the outside, and to a light emission control device.

### BACKGROUND

In general, a light-emitting device (or a lighting device) refers to a device that achieves the purpose of lighting by reflecting, refracting, and transmitting light from a light source. The light-emitting device may be classified into an indirect light-emitting device, a semi-indirect light-emitting device, a full-diffusion light-emitting device, a semi-direct light-emitting device, and a direct light-emitting device based on light distribution.

With developments of technologies, the light-emitting device is being used for various purposes. For example, the light-emitting device may be installed on the exterior of a building to produce a media facade that implements media functionality. In another example, the light-emitting device may be used as a portable cheering device at a performance venue for sports events or concerts with illumination at or below a specific level.

Conventional light-emitting devices have limitations in providing cheering effects that correspond to an artist's sound source encountered in everyday settings, rather than in performance environments. For example, a user may listen to a sound source through various means, such as a general audio device, television or radio broadcasts, or audio equipment installed in public areas. Accordingly, in order to more specifically address the above-described problems, light-emitting devices have been developed to provide cheering effects for sound sources from performance venues and those encountered in daily life, respectively, through different modes.

Further, a master device has been developed to control light-emitting devices to provide a production effect corresponding to a sound source reproduced in a specific space, without requiring a separate pairing operation.

### DISCLOSURE OF THE INVENTION

### Problems to Be Solved by the Invention

The present disclosure is conceived to receive and recognize a sound source that is being output in a performance venue or in a non-performance environment, and perform a light-emitting operation suitable for the recognized sound source to produce a cheering effect.

Also, the present disclosure is conceived to receive a sound source that is being output in a performance venue or in a non-performance environment and includes control information and synchronization information, and produce a cheering effect based on the received sound source.

However, the problems to be solved by the present disclosure are not limited to the above-described problems. Although not described herein, other problems to be solved by the present disclosure can be clearly understood by a person with ordinary skill in the art from the following descriptions.

### Means for Solving the Problems

To achieve the above-described problems, a light-emitting device according to the present disclosure includes a communication unit, a sensing unit, a light-emitting unit, and a processor electrically connected to the communication unit, the sensing unit, and the light-emitting unit. When the light-emitting device is in a first mode, the processor controls the light-emitting unit to emit a color and pattern indicated by a first light emission control signal received from a light emission control device of a performance venue through the communication unit. When the light-emitting device is in a second mode, the processor receives a sound source output from the outside through the sensing unit, obtains a second light emission control signal corresponding to the received sound source, and controls the light-emitting unit to emit a color and pattern indicated by the obtained second light emission control signal.

Also, to achieve the above-described problems, a light emission control device according to the present disclosure includes an antenna, a communication unit, a sensing unit, and a processor electrically connected to the antenna, the communication unit, and the sensing unit. The processor receives a sound source output from the outside through the sensing unit. When the light emission control device is equipped with a database in which at least one sound source and light emission control information respectively mapped to the at least one sound source are stored, the processor searches the database for light emission control information mapped to a sound source identical to the received sound source. When the light emission control device is not equipped with the database, the processor generates light emission control information for instructing light emission of a specific color and pattern based on the received sound source, and transmits, through the antenna, a light emission control signal corresponding to the searched or generated light emission control information.

A computer program stored in a computer-readable recording medium to implement and execute the present disclosure may be further provided.

Also, a computer-readable recording medium to record a computer program for executing a method for implementing the present disclosure may be provided.

### Effects of the Invention

According to the above-described means for solving the problems, it is possible to receive and recognize a sound source that is being output in a performance venue or in a non-performance environment, and perform a light-emitting operation suitable for the recognized sound source to produce cheering effects.

According to the above-described means for solving the problems, it is also possible to produce cheering effects in everyday settings without requiring a separate synchronization process, by extracting control information included in a sound source and controlling the cheering effects based on the extracted control information.

Furthermore, the effects of the present disclosure are not limited to the above-described effects. Although not described herein, other effects of the present disclosure can be clearly understood by a person with ordinary skill in the art from the following descriptions.

### BRIEF DESCRIPTION OF THE DRAWINGS

FIG. 1 is a conceptual diagram illustrating a lighting effect production system according to an embodiment of the present disclosure.

FIG. 2 is a block diagram illustrating a light emission control device according to an embodiment of the present disclosure.

FIG. 3 is a conceptual diagram illustrating a lighting effect production system according to an embodiment of the present disclosure.

FIG. 4A is a block diagram illustrating a configuration of a sound source according to an embodiment of the present disclosure.

FIG. 4B illustrates a structure of a sound source in a time domain according to an embodiment of the present disclosure.

FIG. 5 is a block diagram illustrating a configuration of a light-emitting device according to an embodiment of the present disclosure.

FIG. 6 is a flowchart illustrating operations performed by the light-emitting device according to an embodiment of the present disclosure.

### DETAILED DESCRIPTION OF THE INVENTION

Like reference numerals refer to like elements throughout the present disclosure. Not all details of embodiments of the present disclosure are described herein, and description of general art to which the present disclosure pertains and overlapping descriptions between embodiments are omitted. Components indicated by terms including “unit,” “module,” “member,” and “block” herein may be implemented by software or hardware. According to different embodiments, a plurality of units, modules, members, and blocks may be implemented by a single element, or each of a single unit, a single module, a single member, and a single block may include a plurality of elements.

Throughout the whole document, a certain part being “connected” to another part includes the certain part being directly connected to the other part or being indirectly connected to the other part. Indirect connection includes being connected through a wireless communication network.

Also, a certain part “including” a certain element signifies that the certain part may further include another element instead of excluding other elements unless particularly indicated otherwise.

Throughout the whole document, the term “on” that is used to designate a position of one element with respect to another element includes both a case that the one element is adjacent to the other element and a case that any other element exists between these two elements.

The terms “first”, “second”, etc. can be used to describe different components, but the components should not be construed as limited by these terms.

A singular expression includes a plural expression unless it is clearly construed in a different way in the context.

A reference numeral provided to each process for convenience of description is used to identify each process. The reference numerals are not for describing an order of the processes, and the processes may be performed in an order different from that shown in the drawings unless a specific order is clearly described in the context.

Hereinafter, the operation principle and embodiments of the present disclosure will be described with reference to the accompanying drawings.

Throughout the whole document, the term “device according to the present disclosure” includes all of various devices which can provide results to a user by performing operation processing. For example, the device according to the present disclosure may include all of a computer, a server device, and a mobile device or may have any one form of a computer, a server device, and a mobile device.

Herein, the computer may include, for example, a notebook computer, a desktop, a laptop, a tablet PC or a slate PC equipped with a web browser.

The server device is a server for processing information by performing communication with an external device, and includes an application server, a computing server, a database server, a file server, a game server, a mail server, a proxy server, a web server, and the like.

The portable device is a wireless communication device providing portability and mobility, and includes all kinds of handheld-based wireless communication devices, such as a personal communications system (PCS), a global system for mobile communications (GSM), a personal digital cellular (PDC), a personal handyphone system (PHS), a personal digital assistant (PDA), an international mobile telecommunication (IMT)-2000, a code division multiple access (CDMA)-2000, a W-code division multiple access (W-CDMA), wireless broadband internet (WiBro) device, a smartphone, and the like, and a wearable device, such as a watch, a ring, a bracelet, an ankle bracelet, a necklace, glasses, contact lenses, or a head-mounted device (HMD).

Functions associated with artificial intelligence according to the present disclosure are performed by a processor and a memory. The processor may include one or more processors. In this case, the one or more processors may include a general-use processor such as a central processing unit (CPU), an application processor (AP) or a digital signal processor (DSP), a graphics-dedicated processor such as a graphics processing unit (GPU) or a vision processing unit (VPU), or an artificial intelligence-dedicated processor such as a neural processing unit (NPU). The one or more processors control input data to be processed according to a predefined operation rule stored in the memory or an artificial intelligence model. Alternatively, when the one or more processors are artificial intelligence-dedicated processors, the artificial intelligence-dedicated processors may be designed as hardware structures specialized in processing of a certain artificial intelligence model.

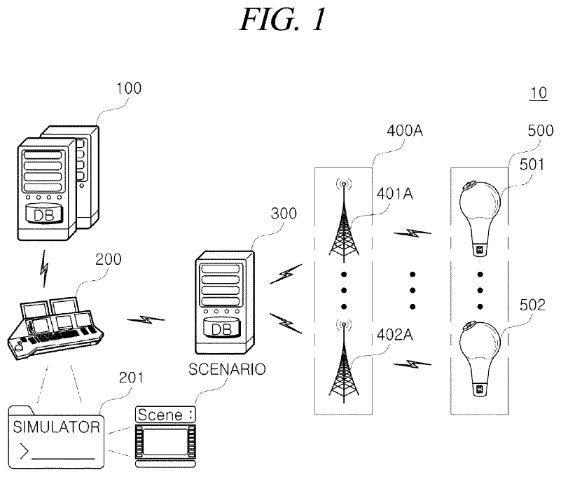

FIG. 1 is a conceptual diagram illustrating a lighting effect production system according to an embodiment of the present disclosure.

Referring to FIG. 1, according to an embodiment of the present disclosure, a lighting effect production system 10 in a performance venue may include a server 100, a light emission control device 200, a master device 300, a transmitter 400A, and a light-emitting device 500. According to the present disclosure, the light emission control device 200 may include a database DB in which at least one sound source and light emission control information respectively mapped to the at least one sound source are stored, the light emission control device 200 may include a simulator 201 for expressing, conceiving, and designing a scenario.

Meanwhile, the database DB may, in some cases, be provided in the light emission control device 200, or may be provided in a separate server such as the server 100 or a cloud server and operate in association with the light emission control device 200 such that the light emission control device 200 can retrieve and use the at least one sound source and corresponding light emission control information stored in the database provided in the server 100 or the cloud server.

The lighting effect production system 10 may produce various types of light emission patterns for performance production, such as cheering effects in the audience area of a performance venue, by controlling an emission state of the light-emitting device 500 using the light emission control device 200. In an embodiment, the light-emitting device 500 may operate in a first mode in the lighting effect production system 10.

The server 100 may store the database DB that stores various data necessary to produce a lighting effect. The database DB may provide various performance data to the light emission control device 200 through wired communication, wireless communication, or a method of directly providing data. For example, the server 100 may provide performance data to the light emission control device 200 through a wired network method such as a coaxial cable or a wired local area network (LAN) (e.g., Ethernet).

For example, on a mobile communication network built according to a mobile communication standard communication method, the server 100 may provide performance data in the form of a packet to the light emission control device 200. For example, the database DB stored in the server 100 may be physically installed into the light emission control device 200 through a storage medium such as a removable disk.

The light emission control device 200 may perform a function of controlling the light-emitting device 500 to produce performance in the performance venue. For example, the light emission control device 200 may be one of electronic devices such as a mobile phone, a smart phone, a laptop computer, a digital broadcasting device, a personal digital assistant (PDA), a portable multimedia player (PMP), a navigation system, a slate PC, a tablet PC, an ultrabook, and a wearable device (for example, a smart watch, smart glasses, a head mounted display (HMD), or the like). The light emission control device 200 may include all electronic devices capable of installing and executing an application related to an embodiment, may include some of components of the electronic device, or may be implemented in various forms capable of interworking therewith.

In the embodiments of the present disclosure, the light emission control device 200 may be one of software for PC and an electronic device such as MA Lighting grandMA2, grandMA3, ETC EOS, ETC ION, ETC GIO, Chroma Q Vista, High End HOG, High End Fullboar, Avolites Sapphire Avolites Tiger, Chamsys MagicQ, Obsidian control systems Onyx, Martin M6, Martin M1, Nicolaudie Sunlite, ESA, ESA2, Lumidesk, SunSuite, Arcolis, Daslight, LightRider, MADRIX, DJ LIGHT STUDIO, DISCO-DESIGNER VJ STUDIO, Stagecraft, Lightkey, or the like. The light emission control device 200 may include the simulator 201 for producing a lighting effect.

The simulator 201 may be an electronic device that implements virtual simulation for implementing lighting effects, software that runs on the electronic device, or a complex device that combines the software and the electronic device. For example, a user may input an electronic signal corresponding to a scene to be produced on the simulator 201. The simulator 201 may convert the input electronic signal to conform to the protocol of the light emission control device 200 and may provide the converted electronic signal to the light emission control device 200 so as to be driven by the light emission control device 200.

Various scenarios may be pre-determined and stored in the simulator 201 or may be input by the user. The scenario may be a design drawing designed to induce a lighting effect by using the light-emitting device 500 throughout the performance time. A performance director may design the scenario and may input the scenario into the simulator 201. The scenario may be different for each scene of the performance or for each song of the performance, and thus may function as a design drawing for producing a cheering effect corresponding to each scene of the performance.

In the embodiments of the present disclosure, the light emission control device 200 may include appropriate software or a computer program for controlling the light-emitting device 500. For example, the light emission control device 200 may include DMX512, RDM, Art-Net, sACN, ETC-Net2, Pathport, Shownet, or KiNET as a protocol for controlling the light-emitting device 500. The light emission control device 200 may transmit a data signal (e.g., a light emission control signal) in an appropriate format such as DMX512, Art-Net, sACN, ETC-Net2, Pathport, Shownet or KiNET. The light emission control device 200 may generate a light emission control signal for controlling the light-emitting device 500. The light emission control signal may be broadcast to the light-emitting device 500, and thus one or more light-emitting devices may emit light depending on the light emission control signal. The light emission control signal may include information about an emission state (e.g., an emission color, a brightness value, a blinking speed, or the like).

In the embodiments of the present disclosure, the light emission control device 200 may include a plurality of input/output ports. The light emission control device 200 may include an input/output port corresponding to or related to a specific data signal format or protocol. For example, the light emission control device 200 may include a first port dedicated to DMX512 and RDM data input/output and a second port dedicated to Art-Net and sACN, ETC-Net2, Pathport, Shownet, KiNET data input/output. The DMX512, RDM, Art-Net, sACN, ETC-Net2, Pathport, Shownet and KiNET protocols are widely known as control protocols for stage lighting installations. According to the embodiments of the present disclosure, the light emission control device 200 may plan more flexible control for the light-emitting device 500 by using control protocols such as DMX512, RDM, Art-Net, sACN, ETC-Net2, Pathport, Shownet, and KiNET.

In an embodiment, the light emission control device 200 may be provided with a sound recognition sensor (e.g., a microphone). The light emission control device 200 may receive and recognize a sound source 400 that is being output inside or outside a performance venue through a sound recognition sensor 220, generate light emission control information based on the recognized sound source 400, and radiate and transmit, through an antenna 240, a light emission control signal corresponding to the light emission control information to the light-emitting device 500 in the performance venue. For example, the light emission control signal may be a wirelessly transmitted radio frequency (RF) signal.

The light emission control device 200 may further include an antenna for radiating the light emission control signal. The light emission control device 200 may radiate the light emission control signal through the antenna. The light-emitting device 500 may receive the light emission control signal and emit light of a predetermined color or pattern.

The light emission control device 200 may further include a database in which at least one sound source and light emission control information respectively mapped to the at least one sound source are stored. The light emission control device 200 may recognize the sound source 400. When the sound source 400 is identical to a sound source stored in the database, the light emission control device 200 may search for light emission control information mapped to the stored sound source, and may radiate a light emission control signal corresponding to the searched light emission control information through the antenna 240.

That is, when the database is provided, the light emission control device 200 searches the database for light emission control information mapped to a sound source identical to the sound source 400 and transmits the information to the light-emitting device 500. When the database is not provided, the light emission control device 200 generates light emission control information for instructing light emission of a specific color and pattern based on the sound source 400 and transmits the information to the light-emitting device 500. A more detailed description thereof will be provided later.

The master device 300 may be provided for efficient signal transmission in the performance venue. The master device 300 may include a database DB. The database of the master device 300 may store the at least one sound source and light emission control information respectively mapped to the at least one sound source. In this case, the light emission control device 200 may be configured to operate in association with the database of the master device 300 such that the light emission control device 200 can search for and use the at least one sound source and the corresponding light emission control information within the database of the master device 300.

The master device 300 may receive a control signal from the light emission control device 200 and provide the control signal to the transmitter 400A, including information from its database DB, or directly provide the control signal to the light-emitting device 500. The master device 300 may be an electronic device such as a mobile phone, a smart phone, a laptop computer, a digital broadcasting device, a personal digital assistant (PDA), a portable multimedia player (PMP), a navigation system, a slate PC, a tablet PC, an ultrabook, and a wearable device (for example, a smart watch, smart glasses, a head mounted display (HMD), or the like), but is not limited thereto. The master device 300 may not be necessarily provided as a separate hardware device, and may be combined and implemented as a part of the light emission control device 200 or as a part of the transmitter 400A.

The transmitter 400A, which is a part of a communication device, may perform a function of amplifying or delivering a light emission control signal received from the light emission control device 200 or the master device 300. For example, the transmitter 400A may be implemented as a communication device such as an antenna. The transmitter 400A may transmit, to the light-emitting device 500, a light emission control signal, which is received from the light emission control device 200 or from the master device 300. When the transmitter 400A receives the light emission control signal for controlling light emission of the light-emitting device 500 from the light emission control device 200 and transmits the light emission control signal to the light-emitting device 500, the light-emitting device 500 may emit light to correspond to an emission color and pattern included in the light emission control signal.

In the embodiments of the present disclosure, the transmitter 400A may be the common name for a plurality of transmitters. For example, the transmitter 400A may include a first transmitter 401A, a second transmitter 402A, and the like. For example, the plurality of transmitters may be provided in the performance venue. The first transmitter 401A for a first section and the second transmitter 402 for a second section are provided such that a wireless control signal can be efficiently transmitted to each seat.

In the embodiments of the present disclosure, it is disclosed that the transmitter 400A is a separate device from the light emission control device 200. However, the light emission control device 200 may include a communication module performing the same function as the transmitter 400A. Accordingly, the light emission control device 200 may perform the same function as the transmitter 400A according to embodiments. The light-emitting device 500 may receive the light emission control signal from the light emission control device 200 and then may emit light.

The transmitter 400A according to the present disclosure may have directivity. A performance planner may arrange the transmitter 400A during a performance planning stage based on the specifications of the transmitter to be used in the performance. Accordingly, the light-emitting device 500 may receive the light emission control signal from the transmitter 400A having identification information corresponding to identification information of the transmitter previously stored in the light-emitting device 500.

Furthermore, the light emission control signal generated from the light emission control device 200 may be received by the master device 300. The master device 300 may convert the light emission control signal into a wireless control signal. The master device 300 may deliver the converted wireless control signal to the transmitter 400A. The transmitter 400A may broadcast the wireless control signal to the light-emitting device 500 within the performance venue by using wireless communication (e.g., RF communication, or the like). Herein, the wireless control signal may be generated by converting control data into a form for controlling the light-emitting device 500 in a wireless communication method.

Under the control of the light emission control device 200, the light-emitting device 500 may perform a function of producing various types of light emission patterns depending on real-time or predetermined control information.

In the embodiments of the present disclosure, the light-emitting device 500 may include a light-emitting element such as a liquid crystal display (LCD) or light-emitting diode (LED), or may be connected to the light-emitting element. The light-emitting device 500 may be a device including any electronic device capable of wireless communication. The light-emitting device 500 may be a small cheering tool held by an audience member at the performance venue for sports events or concerts. For example, the light-emitting device 500 may be a mobile phone, the wireless light-emitting device 500, a lighting stick, a lighting bar, a lighting ball, a lighting panel, and a device equipped with a light source that is wirelessly controllable. In the present disclosure, the light-emitting device 500 may be referred to as a lighting device, a receiver, a controlled device, a slave, or a slave lighting device. Also, the light-emitting device 500 may include a wearable device to be attached to and/or worn on a part of the body, such as wrist or chest.

In the embodiments of the present disclosure, the light-emitting device 500 may interpret the light emission control signal received from the transmitter 400A based on previously stored identification information of the transmitter 400A, and may emit light. Specifically, the light-emitting device 500 may compare the pre-stored identification information of the transmitter 400A with identification information of the transmitter included in the light emission control signal. When the pre-stored identification information of the transmitter is the same as the identification information included in the light emission control signal, the light-emitting device 500 may emit light to correspond to a light emission pattern included in the corresponding light emission control signal.

In the embodiments of the present disclosure, the light-emitting device 500 may be the common name for a plurality of light-emitting devices. For example, the light-emitting device 500 may include a first light-emitting device 501, a second light-emitting device 502, and the like. For example, a plurality of light-emitting devices may be located in the performance venue, and the first light-emitting device 501 located in the first section may receive a control signal from the first transmitter 401A and the second light-emitting device 502 located in the second section may receive a control signal from the second transmitter 402A. Accordingly, even though a plurality of light-emitting devices is located in the performance venue, distributed processing of control signals may be possible.

According to the embodiments of the present disclosure, the lighting effect production system 10 may produce a group cheering effect of the audience. For example, the group cheering effect may be a crowd wave cheering effect. In an embodiment, the master device 300 may broadcast a light emission control signal for the group cheering effect to the performance venue. The light-emitting device 500 located in the performance venue may blink in response to the light emission control signal. Alternatively, the light-emitting device 500 may emit light at a low intensity in response to the light emission control signal.

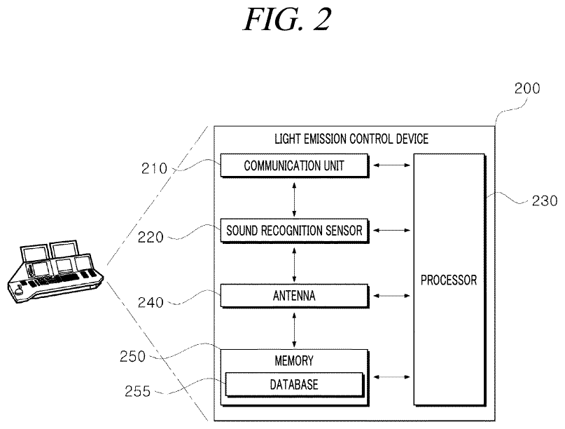

FIG. 2 is a block diagram illustrating the light emission control device 200 according to an embodiment of the present disclosure. In FIG. 2, the same components as in FIG. 1 will be omitted from the explanation.

The light emission control device 200 may include a communication unit 210, the sound recognition sensor 220, a processor 230, the antenna 240, and a memory 250.

The communication unit 210 may communicate with various types of external devices depending on various types of communication methods. The communication unit 210 may include at least one of a wireless-fidelity (WiFi) chip, a Bluetooth™ chip, a wireless communication chip, a near field communication (NFC) chip, and a radio frequency identification (RFID) chip.

According to the mobile communication technology of the present disclosure, the communication unit 210 may transmit and receive a wireless signal to and from at least one of a base station, an external device, and an external server on a mobile communication network established depending on technical standards or communication methods (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), and the like).

Further, the wireless technologies of the present disclosure includes, for example, wireless LAN (WLAN), Wireless-Fidelity (Wi-Fi), Wi-Fi Direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and the like.

Furthermore, the communication technology of the present disclosure may include a communication support technology by using at least one of Bluetooth™, radio frequency identification (RFID), infrared data association (IrDA), ultra wide band (UWB), ZigBee, near field communication (NFC), Wi-Fi, Wi-Fi Direct, wireless universal serial bus (USB), transistor-transistor logic (TTL), USB, IEEE1394, Ethernet, musical instrument digital interface (MIDI), RS232, RS422, RS485, optical communication, and coaxial cable communication.

The sound recognition sensor 220 may receive and recognize the sound source 400 of the present disclosure from the outside of the light emission control device 200. For example, the sound recognition sensor 220 may include a microphone that detects sound in the audible frequency band and/or the ultrasonic frequency band.

The processor 230 may control overall operations of the light emission control device 200 and, in more detail, may control operations of the other components consisting the light emission control device 200. The processor 230 may be implemented with a general-purpose processor, a special-purpose processor, or an application processor. In the embodiments of the present disclosure, the processor 230 may be implemented as an operation processor (e.g., a central processing unit (CPU), a graphic processing unit (GPU), an application processor (AP), and the like) including dedicated logic circuits (e.g., a field programmable gate array (FPGA), application specific integrated circuits (ASICs), and the like), but is not limited thereto.

The antenna 240 may radiate, to the outside, a light emission control signal (e.g., an RF signal) generated by the processor 230. In an embodiment, the antenna 240 may be included in the communication unit 210.

The memory 250 may be a local storage medium supporting various functions of the light emission control device 200. The memory 250 may store a simulator 201 (FIG. 1) capable of being driven in the light emission control device 200, application programs, data for operation of the light emission control device 200, and commands. At least a part of the application programs may be downloaded from an external device (e.g., the server 100) through wireless communication. The application programs may be stored in the memory 250, may be installed on the light emission control device 200, and may be driven by the processor 230 of the light emission control device 200 to perform an operation (or function).

The memory 250 may be a dynamic random access memory (DRAM) such as a double data rate synchronous dynamic random access memory (DDR SDRAM), a low power double data rate (LPDDR) SDRAM, a graphics double data rate (GDDR) SDRAM, a rambus dynamic random access memory (RDRAM), DDR2 SDRAM, DDR3 SDRAM, or DDR4 SDRAM.

In an embodiment, the memory 250 may include a database 255. The database 255 may store at least one sound source 400 and light emission control information respectively mapped to the at least one sound source 400 according to the present disclosure. In an embodiment, a plurality of types of light emission control information may correspond to a single sound source 400. The sound source 400 will be described later.

However, the embodiments of the present disclosure need not be limited thereto. In the embodiments of the present disclosure, even when a power supply to the light emission control device 200 is cut off, data needs to be stored in the memory 250. Accordingly, the memory 250 may be provided as a writable non-volatile memory to reflect changes. However, the present disclosure is not limited thereto. For example, a flash memory, EPROM or EEPROM, resistive memory cells such as a resistive RAM (ReRAM), a phase change RAM (PRAM), a magnetic RAM (MRAM), a spin-transfer torque MRAM, a conductive bridging RAM (CBRAM), a ferroelectric RAM (FeRAM), and other types of memory may be applied to the memory 250. Alternatively, the memory 250 may be implemented with various types of devices such as an embedded multimedia card (eMMC), universal flash storage (UFS), compact flash (CF), secure digital (SD), micro secure digital (Micro-SD), mini secure digital (Mini-SD), extreme digital (xD), or memory stick. For convenience of description in the present disclosure, it is described that all pieces of instruction information are stored in the single memory 250. However, the present disclosure is not limited thereto. For example, the memory 250 may be equipped with a plurality of memories.

According to the embodiments of the present disclosure, the light emission control device 200 may broadcast a light emission control signal that instructs a group cheering effect (e.g., a crowd wave cheering effect). The light emission control signal for the group cheering effect may be generated by the performance director. In an embodiment, the light emission control signal may control the light-emitting device 500 located in the performance venue to blink and to detect movement of the light-emitting device 500 by using at least one sensor. In an embodiment, the light emission control signal may include light emission control information for at least one of an emission color, an emission pattern, and an emission intensity of the light-emitting device 500 during group cheering. The description of the light emission control signal is merely exemplary, and the embodiments of the present disclosure are not limited thereto.

In an embodiment, the processor 230 of the light emission control device 200 may receive and recognize the sound source 400 that is being output through a speaker disposed in a specific space (e.g., inside or outside the performance venue) by using the sound recognition sensor 220. For example, the sound recognition sensor 220 may recognize a pitch and/or a volume of the sound source 400.

In an embodiment, the processor 230 may generate light emission control information based on the sound source 400 recognized by the sound recognition sensor 220, and may radiate and transmit, through the antenna 240, a light emission control signal corresponding to the light emission control information to the light-emitting device 500 within the performance venue. The light emission control signal may be radiated into the specific space in the form of an RF signal through the antenna 240. The light-emitting device 500 may receive the light emission control signal and may perform a light-emitting operation depending on at least one of an emission color, an emission pattern, and an emission intensity indicated by the light emission control signal.

Further, when the recognized sound source 400 is identical to a sound source stored in the database 255, the processor 230 may search for light emission control information mapped to the stored sound source and may radiate the light emission control signal corresponding to the searched light emission control information through the antenna 240.

That is, when the database is provided, the processor 230 searches the database for light emission control information mapped to a sound source identical to the sound source 400 and transmits the information to the light-emitting device 500. When the database is not provided, the processor 230 generates light emission control information for instructing light emission of a specific color and pattern based on the sound source 400 and transmits the information to the light-emitting device 500.

Furthermore, when generating the light emission control information, the processor 230 may identify at least one of the volume and pitch of the sound source 400 and may generate light emission control information that instructs at least one of different emission colors, emission patterns, or emission intensities based on at least one of the identified volume and pitch of the sound source 400. In one example, the processor 230 may generate light emission control information that instructs random light emission based on at least one of the volume and pitch of the sound source 400. Moreover, the light emission control information may be configured to have a different ratio of random light emission according to user selection.

When generating the light emission control information, the processor 230 may further recognize and identify at least one of a genre, type, or mood of the sound source 400 through the sound recognition sensor 220, and may generate light emission control information that instructs at least one of different emission colors, emission patterns, or emission intensities based on at least one of the identified genre, type, or mood according to user selection. In one example, the processor 230 may further recognize at least one of the genre, type, or mood of the sound source 400 based on at least one of the volume and pitch of the sound source 400 through the sound recognition sensor 220.

Furthermore, the processor 230 may generate light emission control information that instructs random light emission based on at least one of the volume and pitch of the sound source 400. Moreover, the light emission control information may be configured to have a different ratio of random light emission according to user selection.

Also, the processor 230 may communicate with a lighting system (not shown) of the performance venue through the communication unit 210 or may be electrically connected to the lighting system, may receive lighting information to be used in the performance venue from the lighting system, and may modify the searched or generated light emission control information based on the received lighting information.

That is, various lightings may be used in each performance venue depending on the purpose, type, and nature of the performance, and, thus, the light-emitting device 500 must perform a light emission operation suitable for or harmonized with the various lightings within the performance venue during light emission for performance production.

Accordingly, in the present disclosure, light emission control information suitable for the sound source is first searched for or generated, and secondarily, the searched or generated light emission control information is corrected so that the resulting light emission operation (for at least one of an emission color, pattern, or intensity) matches or harmonizes with the lightings within the performance venue.

For example, a light emission operation that matches or harmonizes with the lightings within the performance venue refers to a light emission operation in which at least one of an emission color, pattern, or intensity is modified so as to match or harmonize with the color, blinking pattern, or brightness of the lightings.

Further, the processor 230 may recognize, through the sound recognition sensor 220, that the output of the sound source 400 has stopped and that a specific person in the performance venue (e.g., a singer or host) is speaking. In this case, the processor 230 may generate light emission control information to control the light-emitting device 500 to emit light of a single color or turn off, thereby allowing the audience to focus on the speech of the specific person (the singer or host).

At least one component may be added or omitted to correspond to the performance of the components shown in FIG. 2. It will be easily understood by a person with ordinary skill in the art that the relative positions of the components may change in correspondence to the performance or structure of the system.

Meanwhile, each component shown in FIG. 2 may include a software component and/or hardware components such as a Field Programmable Gate Array (FPGA) and an Application Specific Integrated Circuit (ASIC).

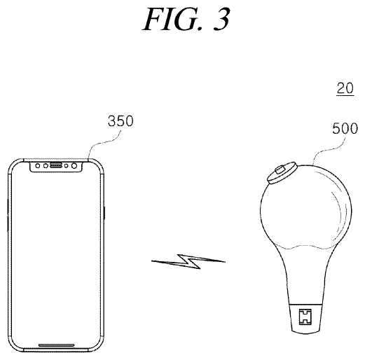

FIG. 3 is a conceptual diagram illustrating a lighting effect production system according to an embodiment of the present disclosure.

In an embodiment, a lighting effect production system 20 may include an electronic device 350 and the light-emitting device 500. In an embodiment, the light-emitting device 500 may operate in a second mode in the lighting effect production system 20.

The electronic device 350 may output a sound source according to an embodiment of the present disclosure through an audio output unit (e.g., a speaker). The light-emitting device 500 may receive the sound source output from the electronic device 350. The light-emitting device 500 may extract light emission control information included in the sound source and emit light based on at least one of an emission color, an emission pattern, and an emission intensity indicated by the extracted light emission control information.

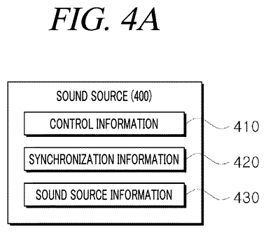

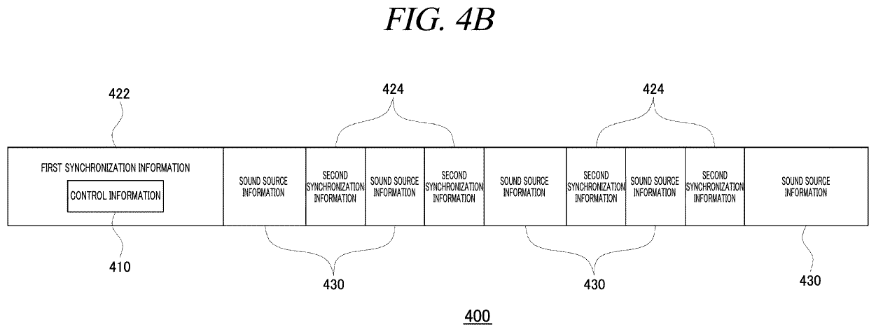

FIG. 4A is a block diagram illustrating a configuration of a sound source according to an embodiment of the present disclosure.

In an embodiment, the sound source 400 of the lighting effect production system 20 may include control information 410, synchronization information 420, and/or sound source information 430. The light-emitting device 500 may receive the sound source 400 and extract the control information 410 and/or the synchronization information 420 included in the sound source 400 in the frequency domain.

In an embodiment, the control information 410 may control the light-emitting device 500 to emit light based on at least one of a predetermined emission color, pattern, and intensity. For example, the control information 410 may include information about an emission state (e.g., an emission color, a brightness value, a blinking speed, a vibration pattern, or the like). The control information 410 may include a time code corresponding to a playback point of the sound source. The time code may be associated with the information about the emission state to indicate a lighting effect (or emission state) to be produced at a specific playback point of the sound source.

In an embodiment, the sound source 400 may include at least one piece of the synchronization information 420. The at least one piece of the synchronization information 420 may include pilot information and fitting information for synchronizing the sound source information 430 with the lighting effect produced by the light-emitting device 500. For example, the pilot information may be information for initiating synchronization. For example, the fitting information may be information used to ensure that the synchronization latency remains below a predetermined time (e.g., 1 ms).

In an embodiment, the sound source information 430 may be audio information based on musical scales. The user may enjoy cheering effects of the light-emitting device 500 together with the sound source information 430.

In an embodiment, the control information 410 and the synchronization information 420 may be output by the electronic device 350 in a frequency band different from that of the sound source information 430. For example, the control information 410 and the synchronization information 420 may be output in an audible or inaudible frequency band. For example, the sound source information 430 may be output in an audible frequency band.

FIG. 4B illustrates a structure of the sound source 400 in a time domain according to an embodiment of the present disclosure.

In an embodiment, the electronic device 350 may reproduce the sound source information 430 included in the sound source 400 through an audio output unit (e.g., a speaker). The electronic device 350 may output the control information 410 and/or at least one piece of the synchronization information 420 through the audio output unit before or during playback of the sound source information 430.

In an embodiment, the light-emitting device 500 may receive the sound source 400 through a sensing unit (e.g., a microphone) 480. The light-emitting device 500 may convert the sound source 400 into a frequency domain and may separate and extract the control information 410 and/or at least one piece of the synchronization information 420 from the sound source information 430 in the frequency domain.

In an embodiment, before reproducing the sound source information 430, the electronic device 350 may output the control information 410 and first synchronization information 422. The control information 410 and the first synchronization information 422 may be output in an audible or inaudible frequency band.

In an embodiment, when the electronic device 350 outputs the control information 410 and the first synchronization information 422 in an audible frequency band, the electronic device 350 may output the control information 410 and the first synchronization information 422 having a predetermined frequency pattern before reproducing the sound source information 430. The light-emitting device 500 may identify the control information 410 and the first synchronization information 422 through a sensing unit (e.g., a microphone) 580.

In an embodiment, when the electronic device 350 outputs the control information 410 and the first synchronization information 422 in an inaudible frequency band, the light-emitting device 500 may convert the sound source 400 into a frequency domain. The light-emitting device 500 may identify the control information 410 and the first synchronization information 422 in the frequency domain. In this case, the first synchronization information 422 may be regarded as pilot information.

In an embodiment, during playback of the sound source 400, the electronic device 350 may output second synchronization information 424. The electronic device 350 may output the second synchronization information 424 in an inaudible frequency band. The light-emitting device 500 may convert the received sound source 400 into a frequency domain and may separate and extract the second synchronization information 424 from the sound source information 430. In this case, the second synchronization information 424 may be regarded as fitting information.

Meanwhile, the light-emitting device 500 may include a database in its memory 550 that is identical to the database 255 of the light emission control device 200, wherein the database 255 stores at least one sound source and light emission control information respectively mapped to the at least one sound source as previously described. In this case, similar to the light emission control information search operation of the light emission control device 200, the light-emitting device 500 may be configured to search the database for a sound source identical to the sound source 400, and to perform a light emission operation based on at least one of an emission color, an emission pattern, and an emission intensity indicated by the light emission control information mapped to the searched sound source.

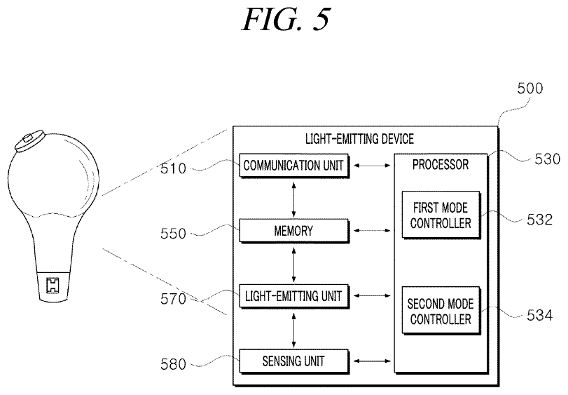

FIG. 5 is a block diagram illustrating the light-emitting device 500 according to an embodiment of the present disclosure. In FIG. 5, the same components as in FIG. 1 and FIG. 2 will be omitted from the explanation.

The light-emitting device 500 may include a communication unit 510, a processor 530, a memory 550, a light-emitting unit 570, and a sensing unit 580.

The communication unit 510 may communicate with various types of external devices depending on various types of communication methods. The communication unit 510 may include at least one of a wireless-fidelity (WiFi) chip, a Bluetooth™ chip, a wireless communication chip, a near field communication (NFC) chip, and a radio frequency identification (RFID) chip.

According to the embodiments of the present disclosure, the communication unit 510 may support a common protocol to communicate with the communication unit 210 of FIG. 2. For example, the communication unit 510 may exchange a wireless signal with at least one of a base station, an external device, and an external server on a mobile communication network established according to GSM, CDMA, CDMA2000, EV-DO, WCDMA, HSDPA, HSUPA, LTE, LTE-A, or the like, or may communicate with the communication unit 210 by using at least one of WLAN, Wi-Fi, Wi-Fi Direct, DLNA, WiBro, WiMAX, Bluetooth™, RFID, Infrared Data Association (IrDA), ultra wideband (UWB), ZigBee, near field communication (NFC), wireless universal serial bus (Wireless USB), transistor-transistor logic (TTL), USB, IEEE1394, Ethernet, a musical instrument digital interface (MIDI), RS232, RS422, RS485, optical Communication, coaxial cable communication.

The processor 530 may control overall operations of the light-emitting device 500 and, in more detail, may control operations of the other components consisting the light-emitting device 500. The processor 530 may be implemented with a general-purpose processor, a special-purpose processor, or an application processor. In the embodiments of the present disclosure, the processor 530 may be implemented as an operation processor (e.g., a central processing unit (CPU), a graphic processing unit (GPU), an application processor (AP), and the like) including a digital signal processor (DSP) capable of converting an analog signal into a digital signal and performing high-speed processing, a micro controller unit (MCU), or a dedicated logic circuit (e.g., a field programmable gate array (FPGA), application specific integrated circuits (ASICs), and the like) supporting the necessary operations in the light-emitting device 500, but is not limited thereto.

In an embodiment, the processor 530 may include a first mode controller 532 and a second mode controller 534. The first mode controller 532 may process a light emission control signal received from the light emission control device 200. The second mode controller 534 may process the sound source 400 received in the lighting effect production system 20. Further, the second mode controller 534 may extract the control information 410 and the synchronization information 420 from the sound source 400. For example, the second mode controller 534 may extract the control information 410 and the synchronization information 420 in the frequency domain based on a Fast Fourier Transform (FFT) algorithm.

The memory 550 may be a local storage medium supporting various functions of the light emission control device 200. The memory 250 may store data for operation of the light emission control device 200, and commands. At least a part of the application programs may be downloaded from an external device (e.g., the server 100) through wireless communication. The application programs may be stored in the memory 550, may be installed on the light emission control device 200, and may be driven by the processor 530 of the light emission control device 200 to perform an operation (or function).

Even when a power supply to the light-emitting device 500 is cut off, data needs to be stored in the memory 550. Accordingly, the memory 550 may be provided as a writable non-volatile memory to reflect changes. For example, the memory 550 may be implemented with a non-volatile memory such as a flash memory, a magnetic RAM (MRAM), a spin-transfer torque MRAM, a conductive bridging RAM (CBRAM), a ferroelectric RAM (FeRAM), a phase change RAM (PRAM), and a resistive RAM (ReRAM). However, the embodiments of the present disclosure need not be limited thereto. For example, the memory 550 may be implemented with a dynamic random access memory (DRAM) such as a double data rate synchronous dynamic random access memory (DDR SDRAM), a low power double data rate (LPDDR) SDRAM, a graphics double data rate (GDDR) SDRAM, a rambus dynamic random access memory (RDRAM), DDR2 SDRAM, DDR3 SDRAM, or DDR4 SDRAM.

According to the embodiments of the present disclosure, the memory 550 may store seat information of a ticket held by an audience member. The seat information of a ticket stored in the memory 550 may include at least one of seat information (e.g., seat 1 in row A) displayed on the ticket, location information (e.g., GPS information) of the corresponding seat in the performance venue, identification information (e.g., the top left seat among 50,000 seats is assigned ‘No.1’ when performance production data is generated) of the corresponding seat, and user information.

According to the embodiments of the present disclosure, the memory 550 may store seat information, which is input from the outside and provided to the light-emitting device 500, and the processor 530 may determine the coordinates of the light-emitting device 500 by reading out the seat information stored in the memory 550. However, the present disclosure is not limited thereto. For example, the memory 550 may store seat information obtained directly from the light-emitting device 500.

According to the embodiments of the present disclosure, the light-emitting device 500 may provide the seat information to the server 100. For example, the light-emitting device 500 may directly provide a signal including the seat information to the server 100 through the communication unit 510, may provide the signal to the server 100 through the user's smart device (not shown), or may provide the signal to the server 100 through the master device 300. The server 100 may centrally manage performance data by storing the seat information.

According to the embodiments of the present disclosure, data stored in the memory 550 may be input into the light-emitting device 500 in the form of firmware during the production stage of the light-emitting device 500, or may be input through an application installed on an audience member's device (e.g., a smartphone or a tablet PC) either before or after entering the performance venue.

In the embodiments of the present disclosure, the audience member (user) may electrically connect their own device to a light-emitting device, and may download control-related information for performance production from an external server through an application installed on the device to store the control-related information in the memory 550. The electrical connection may be made through short-range wireless communication or a physical connection between the device and the light-emitting device 500.

In the embodiments of the present disclosure, the data stored in the memory 550 may be input during a ticket verification process prior to admission. Specifically, the audience may perform a performance ticket verification process before entering the performance venue. In this case, a performance staff may directly input seat information included in a ticket into the light-emitting device 500, or may receive the seat information included in the ticket by using an OCR function or a 2D electronic code reader function, such as a barcode or QR code, through an information check device (not shown). The performance staff may provide the light-emitting device 500 with control-related information associated with location information corresponding to the seat information, and may store the control-related information in the memory 550.

In the embodiments of the present disclosure, the performance data may be location information for each seat in the performance venue. Also, the information check device may provide the light-emitting device 500 with the control-related information associated with the location information through real-time communication with an external server (e.g., 100 in FIG. 1) in the performance venue, or may store the control-related information associated with the location information in advance during a performance planning stage and provide the control-related information to the light-emitting device 500 in the performance venue.

In the embodiments of the present disclosure, the information check device may include an electronic device such as a kiosk (not shown). In this case, the audience may directly perform a performance ticket verification process through the kiosk. The kiosk may receive electronic code information (in other words, information read through a barcode, a QR code, an RFID, an NFC, or the like) included in the ticket, may provide the light-emitting device 500 with the control-related information associated with the location information corresponding to the electronic code information, and may store the control-related information in the memory 550. In this case, the kiosk may store the control-related information associated with the location information in advance, through communication with an external server (e.g., 100 in FIG. 1) or during a performance planning stage.

According to the embodiments of the present disclosure, the memory 550 may store color data in advance. As described above, the color data may be stored during a manufacturing stage of the light-emitting device 500, or may be previously stored before a performance, such as before or after entering the performance venue to ensure the smooth production of lighting effects during the performance. In an embodiment, the color data may include at least one of a color, a pattern, and an intensity emitted by the light-emitting device 500 during group cheering.

According to the embodiments of the present disclosure, the color data may include RGB values arranged to emit light of a predetermined color depending on the data representation range. To represent all colors, RGB values having three color channels need to be specified by 3 bytes. However, in a scene intended for production in the performance venue, it may be unnecessary to substantially represent the full spectrum of natural colors, and a reduction in data transmission and throughput may be required. Accordingly, the color data may include a mapping table for colors to be displayed by the light-emitting device 500 depending on a scenario.

According to the embodiments of the present disclosure, the memory 550 may be equipped with a database that is identical to the database 255 in which at least one sound source and light emission control information respectively mapped to the at least one sound source are stored.

The light-emitting unit 570 may include one or more light source elements. The light source elements may be, for example, light-emitting diodes (LEDs), or the like. Also, the light-emitting unit 570 may output light of various colors according to RGB color information by using the light source elements.

The sensing unit 580 may sense at least one of internal information of the present device, surrounding environmental information of the present device, and user information, and may generate a sensing signal corresponding thereto. The controller may, based on the sensing signal, control driving or operation of the present device, or perform data processing, functions, or operations associated with an application program installed on the present device. The sensing unit may include at least one of a sound recognition sensor (microphone) for receiving and recognizing a sound source output from the outside, a proximity sensor, an illumination sensor, a touch sensor, an acceleration sensor, a magnetic sensor, a gravity sensor (G-sensor), a gyroscope sensor, a motion sensor, an RGB sensor, an infrared (IR) sensor, a fingerprint scan sensor, an ultrasonic sensor, an optical sensor (e.g., a camera), an environmental sensor (e.g., including at least one of a barometer, a hygrometer, a thermometer, a radiation detection sensor, a thermal detection sensor, and a gas detection sensor), and a chemical sensor (e.g., a healthcare sensor or a biometric sensor). Meanwhile, the present device may also utilize combined sensing information from at least two of these sensors.

In an embodiment, the light-emitting device 500 may operate in a first mode or a second mode.

In an embodiment, the light-emitting device 500 may provide a production effect according to the lighting effect production system 10 in the first mode. The operation of the light-emitting device 500 in the first mode may be performed by the first mode controller 532.

In the first mode, the processor 530 may receive a light emission control signal through the communication unit 510, and may emit light of a color based on the light emission control signal through the light emitting unit 570. In an embodiment, the light-emitting device 500 may provide a production effect according to the lighting effect production system 20 in the second mode. The operation of the light-emitting device 500 in the second mode may be performed by the second mode controller 534.

The light-emitting device 500 may perform operations of Mode 2-1 and Mode 2-2 within the second mode. That is, the second mode performs a light emission operation associated with receiving a sound source, and the operations of Mode 2-1 and Mode 2-2 will be described separately below.

First, in Mode 2-1, the processor 530 may control the second mode controller 534 to receive and recognize the sound source 400 through the sensing unit 580, search the database for a sound source identical to the recognized sound source 400, and perform a light emission operation based on at least one of an emission color, an emission pattern, and an emission intensity indicated by the light emission control information mapped to the searched sound source.

Then, in Mode 2-2, the processor 530 may control the second mode controller 534 to receive and recognize the sound source 400 through the sensing unit 580, extract the control information 410 and the synchronization information 420 from the recognized sound source 400, and control the light emitting unit 570 to perform a light emission operation based on at least one of an emission color, an emission pattern, and an emission intensity indicated by the extracted control information 410, thereby providing a lighting production effect corresponding to the sound source 400. Further, the processor 530 may synchronize the lighting production effect with a playback point of the sound source information 430 based on the control information 410.

According to an embodiment of the present disclosure, in a space with predetermined seats (e.g., a performance venue, theater, café, or restaurant), the light-emitting device 500 may operate in the second mode rather than the first mode. In this case, the processor 530 may produce a lighting effect based on seat information stored in the memory 550. Specifically, the processor 530 may emit light of a predetermined color or pattern based on the seat information and the sound source output in the space with predetermined seats. In this case, a plurality of light-emitting devices in the space with predetermined seats can provide a group cheering effect based on the seat information.

At least one component may be added or omitted to correspond to the performance of the components shown in FIG. 5. It will be easily understood by a person with ordinary skill in the art that the relative positions of the components may change in correspondence to the performance or structure of the system.

Meanwhile, each component shown in FIG. 5 may include a software component and/or hardware components such as a Field Programmable Gate Array (FPGA) and an Application Specific Integrated Circuit (ASIC).

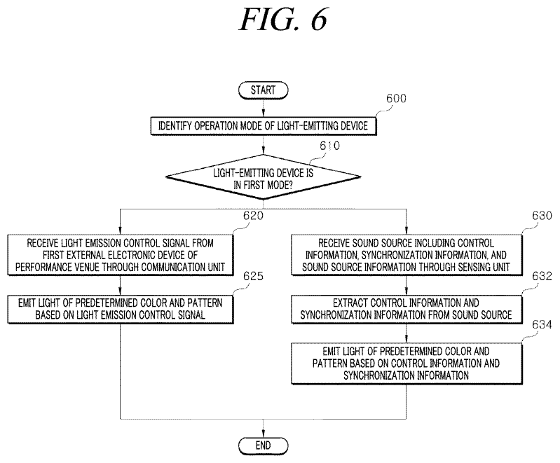

FIG. 6 is a flowchart illustrating operations performed by the light-emitting device according to an embodiment of the present disclosure.

In an operation 600, the light-emitting device 500 may identify an operation mode of the light-emitting device 500. In an embodiment, the operation mode of the light-emitting device 500 may be set by the user. For example, the user may operate an input unit (e.g., a button or switch) of the light-emitting device 500 to set the light-emitting device 500 to operate in the first mode or the second mode. In another embodiment, the light-emitting device 500 may operate in the first mode in response to a light emission control signal from the master device 300 of the performance venue. In this case, the light-emitting device 500 may normally operate in the second mode.

In an operation 610, when the operation mode of the light-emitting device 500 is the first mode, the process may proceed to an operation 620. In the operation 620, the light-emitting device 500 may receive a light emission control signal from an external electronic device (e.g., the master device 300) of the performance venue through the communication unit 510. In an operation 625, the light-emitting device 500 may perform a light emission operation based on at least one of an emission color, an emission pattern, and an emission intensity indicated by the received light emission control signal.

In the operation 610, when the operation mode of the light-emitting device 500 is Mode 2-1, the light-emitting device 500 may receive and recognize the sound source 400 through the sensing unit 580, search the database for a sound source identical to the recognized sound source 400, and perform a light emission operation based on at least one of an emission color, an emission pattern, and an emission intensity indicated by light emission control information mapped to the searched sound source.

Further, in the operation 610, when the operation mode of the light-emitting device 500 is Mode 2-2, the process may proceed to an operation 630. In the operation 630, the light-emitting device 500 may receive the sound source 400 including the control information 410, the synchronization information 420, and/or the sound source information 430 through the sensing unit 580. In an operation 632, the light-emitting device 500 may extract the control information 410 and the synchronization information 420 from the sound source 400. In an operation 634, the light-emitting device 500 may perform a light emission operation based on at least one of an emission color, an emission pattern, and an emission intensity indicated by the control information 410 and the synchronization information 420. Meanwhile, the embodiments of the present disclosure may be implemented in the form of a recording medium storing instructions executable by a computer. The instructions may be stored in the form of program code and, when executed by a processor, may generate a program module to perform the operations of the embodiments. The recording medium may be implemented as a computer-readable recording medium.

The computer-readable recording medium includes all kinds of recording media in which instructions which can be decoded by a computer are stored. For example, there may be a Read Only Memory (ROM), a Random Access Memory (RAM), a magnetic tape, a magnetic disk, a flash memory, and an optical data storage device.

Although an embodiment of the present disclosure are described with reference to the accompanying drawings, it will be understood by a person with ordinary skill in the art to which the present disclosure pertains that the present disclosure may be carried out in other detailed forms without changing the scope and spirit or the essential features of the present disclosure. Therefore, the embodiments described above are provided by way of example in all aspects, and should be construed not to be restrictive.

What is claimed is:

1. A light emission control device in a performance venue, comprising:
an antenna;
a communication unit;
a sensing unit; and
a processor electrically connected to the antenna, the communication unit, and the sensing unit,
wherein the processor receives a sound source output from the outside through the sensing unit, and
when the light emission control device is equipped with a database in which at least one sound source and light emission control information respectively mapped to the at least one sound source are stored, the processor searches the database for light emission control information mapped to a sound source identical to the received sound source, and
when the light emission control device is equipped with the database but the light emission control information mapped to the sound source identical to the received sound source is not searched or when the light emission control device is not equipped with the database, the processor generates light emission control information for instructing light emission of a specific color and pattern based on the received sound source, and
the processor transmits, through the antenna, a light emission control signal corresponding to the searched or generated light emission control information in order for a plurality of light-emitting devices installed in the performance venue, and
when the light emission control information is generated, the processor identifies at least one of a volume and a pitch of the received sound source, and
the processor generates the light emission control information based on at least one of the volume and the pitch of the received sound source.

2. The light emission control device of claim 1,
wherein each of the plurality of light-emitting devices operates in one of a plurality of modes, and when each of the plurality of light-emitting devices operates in a first mode among the plurality of modes, each light-emitting device operates according to the light emission control information.

3. A light emission control device in a performance venue, comprising:
an antenna;
a communication unit;
a sensing unit; and
a processor electrically connected to the antenna, the communication unit, and the sensing unit,
wherein the processor receives a sound source output from the outside through the sensing unit, and
when the light emission control device is equipped with a database in which at least one sound source and light emission control information respectively mapped to the at least one sound source are stored, the processor searches the database for light emission control information mapped to a sound source identical to the received sound source, and
when the light emission control device is equipped with the database but the light emission control information mapped to the sound source identical to the received sound source is not searched or when the light emission control device is not equipped with the database, the processor generates light emission control information for instructing light emission of a specific color and pattern based on the received sound source, and
the processor transmits, through the antenna, a light emission control signal corresponding to the searched or generated light emission control information in order for a plurality of light-emitting devices installed in the performance venue, and
each of the plurality of light-emitting devices is mapped to seat information of the performance venue, and
when the light emission control information is generated, the processor identifies at least one of a volume and a pitch of the received sound source, and
the processor generates the light emission control information based on at least one of the volume and the pitch of the received sound source.

4. The light emission control device of claim 2,
wherein the processor communicates with a lighting system of the performance venue through the communication unit or is electrically connected to the lighting system, and receives lighting information to be used in the performance venue from the lighting system and modifies the searched or generated light emission control information based on the received lighting information.

5. The light emission control device of claim 3,
wherein the processor communicates with a lighting system of the performance venue through the communication unit or is electrically connected to the lighting system, and receives lighting information to be used in the performance venue from the lighting system and modifies the searched or generated light emission control information based on the received lighting information.

6. The light emission control device of claim 2,
wherein the processor further identifies at least one of a genre, type, or mood of the received sound source, and generates the light emission control information based on at least one of the identified genre, type, or mood of the received sound source.

7. The light emission control device of claim 3,
wherein the processor further identifies at least one of a genre, type, or mood of the received sound source, and generates the light emission control information based on at least one of the identified genre, type, or mood of the received sound source.

8. The light emission control device of claim 3,
wherein each of the plurality of light-emitting devices operates in one of a plurality of modes, and when each of the plurality of light-emitting devices operates in a first mode among the plurality of modes, each light-emitting device operates according to the light emission control information.

9. A light emission control device in a performance venue, comprising:
an antenna;
a communication unit;
a sensing unit; and
a processor electrically connected to the antenna, the communication unit, and the sensing unit,
wherein the processor receives a sound source output from the outside through the sensing unit, and
when the light emission control device is equipped with a database in which at least one sound source and light emission control information respectively mapped to the at least one sound source are stored, the processor searches the database for light emission control information mapped to a sound source identical to the received sound source, and
when the light emission control device is not equipped with the database, the processor generates light emission control information for instructing light emission of a specific color and pattern based on the received sound source.

10. The light emission control device of claim 9,
wherein the processor transmits, through the antenna, a light emission control signal corresponding to the searched or generated light emission control information in order for a plurality of light-emitting devices installed in the performance venue.

11. The light emission control device of claim 10,
wherein each of the plurality of light-emitting devices operates in one of a plurality of modes, and when each of the plurality of light-emitting devices operates in a first mode among the plurality of modes, each light-emitting device operates according to the light emission control information.

12. The light emission control device of claim 11,
wherein the processor communicates with a lighting system of the performance venue through the communication unit or is electrically connected to the lighting system, and receives lighting information to be used in the performance venue from the lighting system and modifies the searched or generated light emission control information based on the received lighting information.

13. The light emission control device of claim 12,
wherein the processor further identifies at least one of a genre, type, or mood of the received sound source, and generates the light emission control information based on at least one of the identified genre, type, or mood of the received sound source.
